(19) United States
(12) Patent Application Publication
(10) Pub. No.: US 2010/0082456 A1
(43) Pub. Date: Apr. 1, 2010

(54) TOOLS IN SUPPORT OF E-COMMERCE INCLUDING INVENTORYLESS E-COMMERCE

(75) Inventor: James Chung, Sayreville, NJ (US)

Correspondence Address: Leason Ellis LLP, 81 Main Street, Suite 503, White Plains, NY, 10601, US

(73) Assignee: Turbo Holdings, Sayreville, NJ (US)

(21) Appl. No.: 12/567,646

(22) Filed: Sep. 25, 2009

Related U.S. Application Data
(60) Provisional application No. 61/150,903, filed on Feb. 9, 2009.
(60) Provisional application No. 61/100,987, filed on Sep. 29, 2008.

(51) Int. Cl. G06Q 30/00; G06Q 20/00; G06F 3/048

(52) U.S. Cl. 705/27; 715/771

(57) ABSTRACT

Methods support e-commerce and advertising through storefronts having respective sets of items for purchase. Items are added to storefronts by owners via a control panel module. Store owners are presented with a selection of items that were previously defined by that particular owner through the control panel module, and are selectively presented with a public subset of further items of storefronts of other owners. The owner inputs commands through the control panel to add at least one of the presented items to the particular storefront, and a database is updated accordingly. If the item belongs to another owner, the added item is associated with the other owner in the database. A payment transaction is completed by a visitor at the particular store, wherein any proceeds from the payment transaction are received by the website and then shared between the particular owner and the respective other owner.

This application claims the benefit of priority under 35 U.S.C. Section 119(e) from U.S. Provisional Application Ser. No. 61/100,987, filed on Sep. 29, 2008, and U.S. Provisional Application Ser. No. 61/150,903, filed on Feb. 9, 2009, both entitled “Tools In Support of E-Commerce Including Inventoryless E-Commerce,” which are hereby incorporated by reference in their respective entireties.

### FIELD OF THE INVENTION

The present invention relates to the field of e-commerce transactions, and more particularly to a system and method in support of referral-based e-commerce transactions.

### BACKGROUND OF THE INVENTION

Numerous websites promote and sell products over the Internet. Vendors enjoy varying degrees of success, in part, as a function of their product offerings, their reputation, their popularity, and any advertising. Generally, vendors offer for sale merchandise that they have in inventory, although there are e-commerce models in which the vendor is leveraging its own reputation or popularity to assist the merchant in closing a sale with a customer. For instance, Amazon.com sells its own merchandise and also hosts other vendors through its website.

There remains a need for further e-commerce transaction models that can facilitate transactions by providing software tools that assist vendors in promoting their wares. There remains a need for software tools that further permit a vendor to earn referral fees for purchases by its customers of products offered by other vendors and that provide management over advertising and referral links. There further exists an unrecognized and distinct need in the area of social websites to have interactive widgets that can be used by members and users of such sites to individually manage and steer traffic from one user-profile to another within the site while benefiting from market forces such as high ratings, high traffic, and the like. The present invention provides systems and methods in the form of software executing in a computer to address these and other needs.

### SUMMARY OF THE INVENTION

In one aspect of the invention, a computer-implemented method for supporting e-commerce at a website is provided in which the website is divided into discrete storefronts within a database. Each storefront has an owner and a respective set of items for purchase and all of the storefronts share a common e-commerce engine executing on a processor of a machine that receives and processes any payment transaction made by a visitor when purchasing an item. A control panel module is provided for a particular owner to add items to a particular storefront for purchase. The control panel module comprises code executing on the processor of the machine and is in communication with the database. An output device connected to the machine presents to the owner any items that were previously defined by that particular owner through the control panel module, and selectively presents a public subset of further items included among the sets of items of the respective storefronts of other owners. At least one of the presented items is added to the particular storefront in response to a command received through the control panel, wherein the adding step comprises updating contents of the database. In the event that any added item is an item for purchase from one of the other owners, the added item is associated with the respective other owner in the database. A payment transaction is completed by the visitor at the particular store using the common e-commerce engine, wherein any proceeds from the payment transaction are received by the website and then shared between the particular owner and the respective other owner.

In another aspect of the invention, a computer-implemented method for supporting e-commerce at a website is provided in which the website is again divided into discrete storefronts within a database, with each storefront having an owner and a respective set of items for purchase by a customer. The discrete storefronts are each defined, in part, by a user-profile associated with the owner and being rendered through a user-interface module. A control panel module is provided for a particular owner to add items to a particular storefront for purchase. The control panel module comprises code executing on the processor of the machine and is in communication with the database. An output device connected to the machine presents to the owner any items that were previously defined by that particular owner through the control panel module, and selectively presents a public subset of further items included among the sets of items of the respective storefronts of other owners. At least one of the presented items is added to the particular storefront in response to a command received through the control panel, wherein the adding step comprises updating contents of the database. In the event that any added item is an item for purchase from one of the other owners, the added item is associated with the respective other owner in the database. A payment transaction is completed between the customer and the particular storefront to purchase said added item, and a message is automatically communicated under software control to the respective other owner that a commission is to be paid for the purchase of said added item from the particular storefront.

In still a further aspect of the invention, a computer-implemented method for supporting e-commerce at a website divides the website into discrete storefronts within a database, wherein each storefront has an owner and optionally has ad spaces to lease. The discrete storefronts optionally can be arranged to share a common e-commerce engine executing on a processor of a machine that receives and processes any payments made in connection with leasing of the ad spaces by the owner. In this aspect, a control panel module is provided for a particular owner to define advertisement spaces within the database for rendering within a particular storefront or elsewhere, the control panel module comprising code executing on a processor of a machine and being in communication with the database, wherein the advertisement spaces are defined based on the one or more advertisement space parameters. The advertisement spaces can be hosted in a variety of locations, including the storefronts of other storefront owners than the particular storefront owner, such as in response to a command received through the control panel. Each advertisement space is associated with the particular owner in the database. When the advertisement space is leased, a payment transaction for the advertisement space is completed, optionally, using any common e-commerce engine, with the proceeds from the payment transaction being received by the website and then tendered to the particular owner, less any commission to the hosting site.

These and other aspects, features and advantages of the invention can be further appreciated from the accompanying drawing figures and discussion of certain embodiments of the invention.

### BRIEF DESCRIPTION OF THE DRAWING FIGURES

FIG. 1 is a flow diagram illustrating a commission-based sales transaction.

FIG. 2 is an exemplary item definition form for adding items into a database of public or private bulletin boards.

FIG. 2A is an exemplary table of attributes associated with an item in the database.

FIG. 3 is a conceptual diagram illustrating a commission-based e-commerce transaction by a buyer interacting with a storefront hosted within a common domain with other storefronts.

FIG. 4 is a flow diagram illustrating operation of a billboard module executing on a computer communicatively coupled to the machine hosting the common domain.

FIG. 5 is a conceptual diagram illustrating an ad space marketplace.

FIG. 6 is a schematic illustration that shows payments for the creation of ad widgets and for the selection of ad space made available by such widgets, as well as a billboard at a particular storefront within the common domain that is made available by the ad widget.

FIG. 6A is a block diagram showing various locations that can support ads under control of a management module.

FIG. 7 is a schematic illustration of a storefront.

FIG. 8 is a diagram illustrating the common e-commerce engine

### DESCRIPTION OF CERTAIN EMBODIMENTS

By way of overview and introduction, the present invention is described in connection with an implementation in which multiple storefronts are accessed through a common domain using a conventional web-browser such as Internet Explorer. The common domain takes the form of “xxxxx.com,” where xxxxx is the domain name. The storefronts each have a respective set of items for purchase through the Internet. Within the common domain, a visitor (e.g., customer) can see the offerings for sale through various, discrete storefronts. The storefronts are “discrete” in that each storefront is registered to an owner who is responsible for decorating the space, filling it with products and attracting visitors to the storefront. From the perspective of the visitor, each storefront presented at the common domain is analogous to a store divided out of the physical space of a shopping mall. From the perspective of the machine hosting the common domain, however, the storefronts all share a common e-commerce engine that receives and processes any payment transactions made by a visitor when purchasing an item from any of the discrete storefronts. Depending on the nature of the hosting site, the storefronts can be predominantly arranged into discrete pages that are defined within, and accessible through, the common domain in order to present a space that is filled with user-selections of messages, pictures, links and data other than products for purchase, such as when the hosting site is a social networking site. Examples of social networking sites include, as a non-limiting list of examples, Facebook.com, MySpace.com, LinkedIn.com, and Twitter.com. Persons that use such networking sites are owners of discrete pages (“homepages”) that include such selected information, and can further include products for purchase. When products are included, the user-homepages comprise a storefront as that term is used in this Specification.

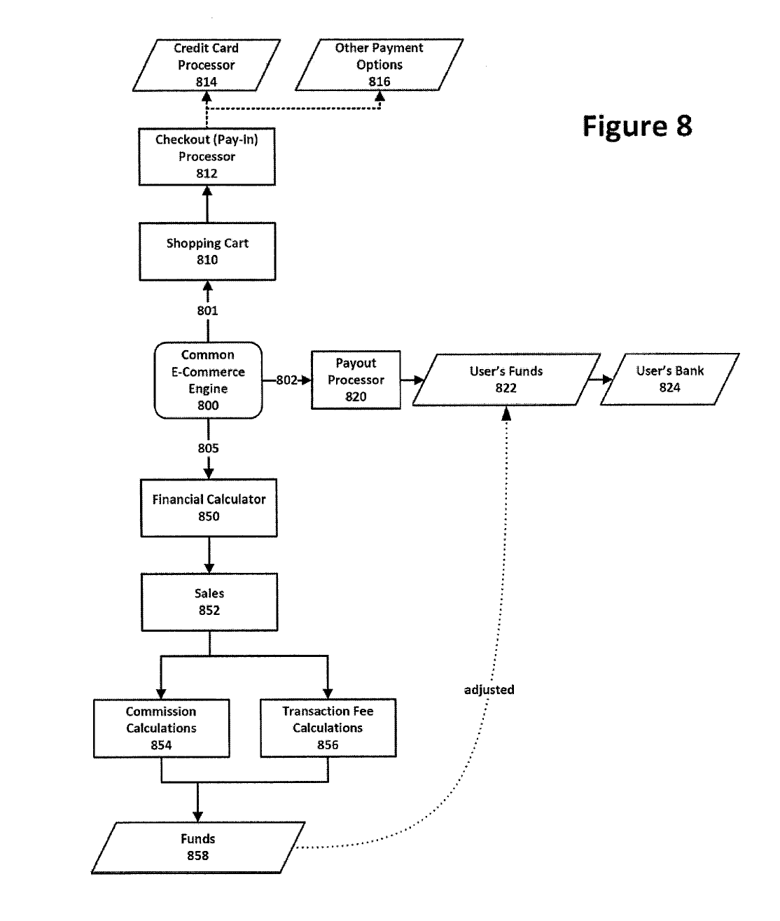

Turning briefly to FIG. 8, the common e-commerce engine enables customers to transact with a single merchant, e.g., the host site xxxxx.com, indicated by arrow 801 while each owner is compensated for the sale of its goods from its storefront indicated by arrow 802. In this way, customers do not have to make a payment through the individual storefronts or to an individual vendor/owner for what might be a single purchase, but rather transact with the common domain associated with multiple storefronts. Use of a common e-commerce engine also enables a storefront owner to be compensated for selling another vendor's goods from his or her storefront, which is calculated using code modules such as can be implemented in software, as described next in connection with block 850 to block 858.

At block 850, a financial calculator module 850 receives data from the ecommerce engine and identifies the parameters of any shopping transaction that a particular customer has completed. For instance, the customer's shopping cart can include one or more items, a shipping destination and an associated shipping charge, and a tax rate associated with the customer and/or destination. The sales are matched against the items from different storefronts by a sales matching module at block 852, meaning that the particular items in the shopping cart are matched to the particular storefronts from which the items were selected, and terms are obtained from a database such as the commission rate for the sale and the like.

While the commission rate can be a default value such as 5% payable to a reseller of another storefront owner's item, the commission rate also can be established by the seller and stored. In either case, the applicable rate is obtained at block 852. At block 854, a commission calculator module makes commission calculations using the applicable commission rate and the sale price of the items from each storefront. More specifically, and as will be appreciated from the discussion below, a commission to the seller is only applicable and is only transferred to store owners who sell items that have been added to their storefronts based on a public listing by another, particular storeowner. The commission to such sellers is calculated using either the default commission rate or a rate established by the particular owner that listed the public item (that was, in fact, sold by the commission-earning seller) times a price paid for a given item added to the seller's store from a public bulletin board (and thereafter associated with that seller). Meanwhile, at block 856, any transaction fee is calculated using a transaction fee module for the benefit of having the common e-commerce engine process the purchase transaction. The funds for that purchase transaction, including the amounts calculated at blocks 854 and 856, are obtained by a funds module at block 858 and distributed, in part, to the storefront owner, as shown by the “adjusted” arrow to block 822, User's Funds.

It should be understood that the same calculations performed at blocks 854 and 856 can be used by the checkout (Pay-in) processor at block 812 to determine the amount of funds to obtain from the customer.

To make a purchase, the buyer adds the desired items and virtual inventories into the shopping cart, as indicated at block 810, and then proceeds to checkout, as at block 812. To complete the purchase at checkout, he or she can enter the credit card information at block 814 or use another payment option at block 816. If the sale is successful, the common e-commerce engine calculates the commissions and transaction fees, as previously described in regard to blocks 854 and 856, from the sales at block 852 and then funds an adjusted amount to appropriate users during the payout from block 820 to block 824.

In general, the percentages of the commissions that the users receive and the common domain earns are predetermined by the common domain. For instance, the commission can be a flat rate, such as 5%. However, it is possible to allow the owner of the items to specify how much commission that the storefront owner receives for those items resold in the storefront. This is appropriate, for example, for items of unusually high value in which a flat rate is not suitable, or for rare items that can attract customers without the need for a full-rate incentive, or for other reasons. To the extent that the owner of the items can specify the commission, that parameter is stored and is available to the commission calculator module at block 854.

The items for sale by any given storefront owner are arranged, stored and managed in a database in a manner that defines the properties of the item for sale (e.g., its price, its features, images of the item and the like). The storefronts themselves can be tagged in the profile to correspond to certain categories (such as apparel, books, computer, electronics, footwear, miscellaneous, movies, office, video games, etc), or are tagged automatically based on the heuristics from the categories of the items in the storefronts.

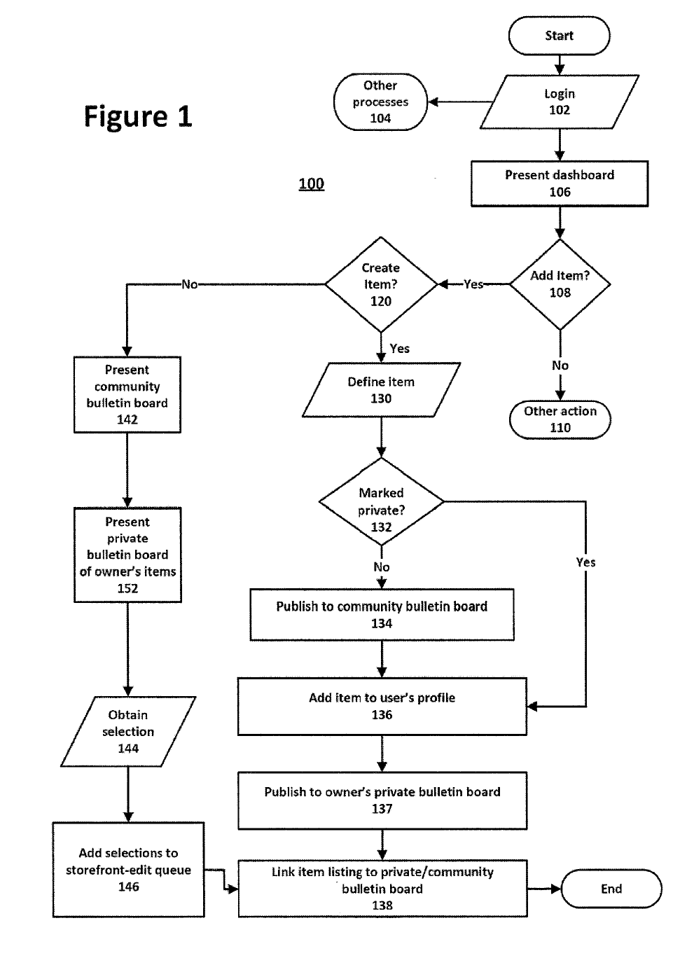

Each user has a profile that associates items with the user, and any associated item can be included as a product or service within one or more storefronts associated with that user. The profile can take the form of a table within a database, with each user having an entry in a table to maintain his or her profile. In accordance with a salient aspect of the invention, the items in the database optionally can be marked so as to enable so-marked items to be included in the storefronts of other owners. FIG. 1 illustrates a flow diagram in which storefront owners can mark items that they are willing to have sold through other storefronts and can select items for inclusion within their storefronts. Items included in a given storefront can be purchased by customers that visit that storefront, and delivery can be fulfilled by the owner whose profile included the item that has been purchased by the paying customer, while a commission flows to the particular storefront owner that had the paying customer in the first place, and payment flows to the item owner.

Referring now to FIG. 1, a storefront owner accesses the login page associated with the storefront's host domain as part of a process 100. This could be a link or directly on the main page of the hosting site. Thus, for example, if the host is makatto.com and the storefronts are included at that host domain, then a link such as “login” can be provided on the main page to allow storefront owners to access a control panel module that is provided and implemented under control of code executing on a processor of a machine and make changes to their respective storefronts. At block 102, an owner enters login information such as a username and password. Assuming that the login is successful, as tested by code executing on a processor of a machine such as the machine that is hosting the common domain or another machine that is communicatively coupled to the Internet or other distributed computer network, various processes can take place, as indicated at terminal block 104, but in relevant part, a dashboard is presented by a dashboard module, as indicated at block 106, through which the owner can manage his or her storefronts. The dashboard provides a number of software tools that assist in management of a virtual storefront including various mechanisms relating to visits by customers, as described further below, but generally including but not limited to collecting statistics, such as billboard revenue and advertising costs, storefront rank or popularity, visitor count, monetary balances with the common domain (e.g., makatto.com) for product sales and commissions, and the like. The dashboard comprises an application or code that executes in a processor of a machine such as the host domain or another machine such as noted above.

In part, the dashboard provides the user with a profile page that maintains, among other things, a record of items that have been defined by the owner for sale through one or more storefronts and any items that have been defined by different owners and selected by the logged-in user for inclusion in one or more of his or her storefronts. The profile page also includes system messages relating to sales performance, commissions, and commission obligations, as will be more clearly understood from the following discussion.

At block 108, owner interaction with the dashboard is tested by the software. The dashboard comprises a control panel that a particular owner can use to add items to his or her profile as well as to one or more owned storefronts so that they can be purchased by visiting customers. The owner indicates that he or she wishes to add an item to his or her profile or to a particular storefront by interacting with the dashboard. If adding an item is the action taken, then the process flow proceeds to block 120 in the figure. Owners add items to their storefronts by selecting one or more items from existing user-profiles. Interaction between a visitor to a given storefront and the added-item can cause pop-ups or click-through page display for further details of the item, availability, cost, shipping, and other information that the owner may wish to include. The storefront owner can define the presentation, interaction, and overall visitor experience to differentiate his or her storefront. On the other hand, if some other action is taken at the dashboard, the process flow proceeds to terminal block 110. Such other action can include a variety of other actions that a particular owner would do to manage the storefront, including, for instance, decorating the storefront with a seasonal decoration (hearts for Valentine's Day, etc.), changing the layout or sales widgets (shelves, carrousels, and other furniture), adding sound or other presentation/interaction features to differentiate the visitor's experience at the owner's storefront from other storefronts.

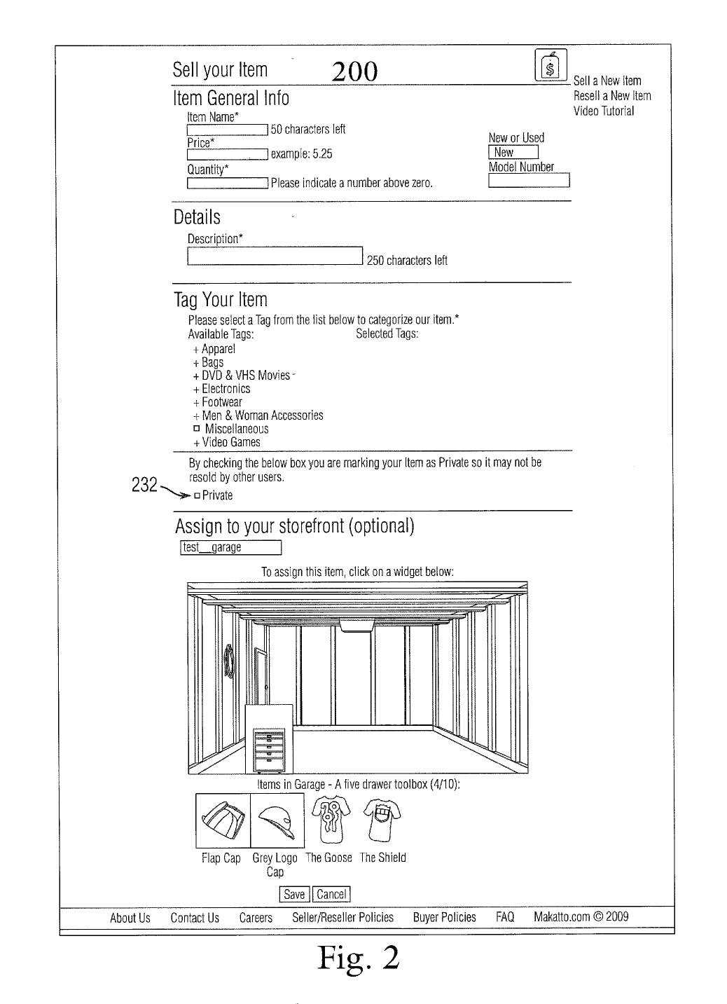

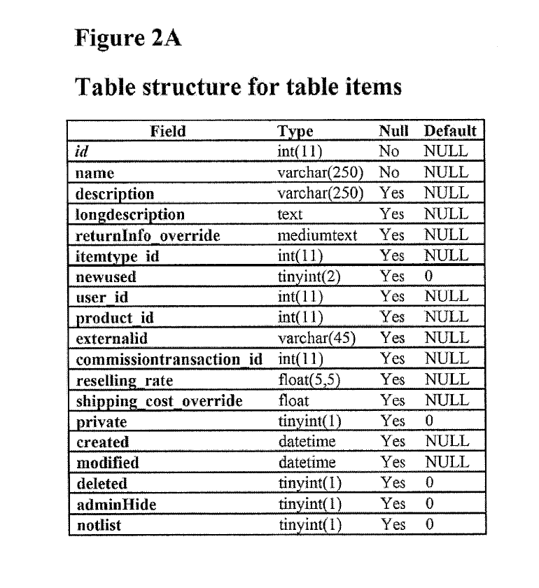

At block 120 the software determines whether the owner has decided to define a new item. In the event that a new item is to be defined, then further steps are taken to create an item record in the database used by the host domain to manage the items presented in the various storefronts. As noted, the new record can comprise an entry in a table that comprises that user's profile. At block 130, the item is defined so that can be included as a virtual ware or service within an owner's storefront or, if marked public (as discussed below), within any of one or more storefronts of other owner's having storefronts hosted at the common domain. The item definition is associated with a particular storefront owner. As well, the identity of the item, its price, and its quantity can all be included in the item definition, for example, using an item-definition form such as shown in FIG. 2.

Part of the item definition is the owner's designation of the item as either private or public. At block 132, the software can test whether the item has been marked as being private. Equivalently, the test at block 132 can test whether the item has been marked as being public. Depending on the owner's designation, the item is published to either a community bulletin board (“public” or “not private”), as indicated at block 134, or not. The owner makes the designation as to how the item is published using the item-definition form, for example, using a checkbox 232 as shown in FIG. 2. If the box is checked, in this example that is a “private” designation that results in the item being presented on a private bulletin board of the owner rather than in a community bulletin board available for review by other storefront owners.

At blocks 136 and 137, the so-defined item is added to the user's profile and is published to the owner's private bulletin board. Any item that has been published to the bulletin board at blocks 134 and 137 can be included as a virtual ware or service for sale within a storefront through a separate process initiated through the dashboard, such as one of the actions 110. Briefly, a storefront-edit process (not shown) includes one or more interface pages that are configured by and provided via an interface module implemented as code executing on a processor of a machine to respond to user actions so as to edit the properties of the storefront itself (e.g., carpeting, wall colors, signage), or the properties of the sales widgets that are to be used to display items (carrousel, shelf, etc.) within the user's profile, or the properties of the final display of the item (e.g., its size). As such, the logged-in user can edit a sales widget and look through the host-site's inventory of items to add to the sales widget. The common domain can provide selections for adjusting storefront properties or widgets for the display of items to the storeowners, though at least some furniture and sales widgets can be purchased from the common domain. These purchases are maintained in records associated with the user-profile and a management module 600 uses this information in connection with rendering each owner's storefront(s).

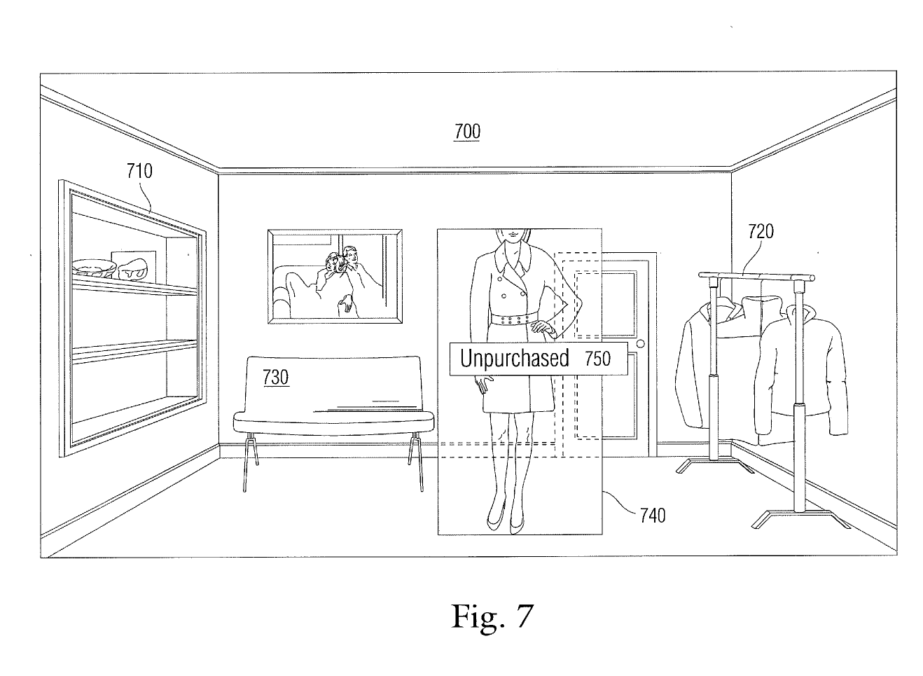

Referring briefly to FIG. 7, a storefront 700 is illustrated schematically to show a selection of sales widgets 710, 720, and 740 arranged in the storefront. Sales widgets 710 and 720 have been purchased and logged in the records associated with the user-profile of that storefront owner. Sales widget 740, on the other hand, is identified as an unpurchased widget via indicia 750, which in this illustration is depicted as a banner with the word “unpurchased.” Other indicia can be used or the sales widget itself can be depicted in a manner that indicates that it has not been purchased (e.g., in a semi-transparent rendering). The management module thereby enables the storefront owner to experiment with sales widget placement, sizing, and style before committing to purchase any particular sales widget(s). The dashboard, including the interface module that permits a storefront owner to edit a storefront, can provide selections that allow the storefront owner to view the storefront as it currently exists (i.e., with the paid-for sales widgets and any inventory in place) the same way that a customer would view the storefront, or to view it with any selected but not paid-for sales widgets.

If a given item in the host-site inventory is private and belongs to only that particular user, the item will be visible to that user and not to others. On the other hand, if such item is private yet does not belong to the logged-in user (i.e., is not in that user's profile, regardless of how many storefronts the user owns), that item will not be visible to that user. Finally, if such item is marked as constituting a public item, it will always be visible to that user and all other users.

An item marked as a public item can be added to the storefronts of the owner that defined the item as well as the storefronts of other storefront owners. The quantities available for sale are linked together across the different storefronts, but only if the particular owner adding the item as described above has designated the item as “public” or “not private.” For each item added, regardless of whether it has been designated as being private, a link between each owner listing the item and the database, as indicated at block 138, ensures that such owners or their respective storefronts are informed of changes in inventory due to sales from other storefronts or any other changed circumstances. The pertinent information concerning each item, including whether it is “public” or not, is preferably stored in a table within the database, such as within the user-profile. An exemplary record is illustrated in FIG. 2A, in which the input data includes a plurality of variables, each having a data type (integer, variable character string, date/time, etc.), default values and the like. The record is populated using information obtained during the login step (block 102, e.g., the user id) and interaction with the item-definition form 200.

Referring back to block 120, if the particular owner is not adding a new item to the user-profile, then the software presents both a community bulletin board of other owners' items, as indicated at block 142, and a private bulletin board of that owner's items, as indicated at block 152. The presentation of community items includes only that subset of items in the database that respective other storefront owners have designated as being “public” or “not private.” Thus, the presentation of community items selectively presents to the particular owner a public subset of items in the database. In part, this presentation is sufficient to permit the store owner to assess the item that is available for listing at his or her storefront, as well as the commission that would be kept if the owner finds a buyer for the item. The software obtains the particular owner's selection at block 144 in response to a command received through the control panel and adds the items to a queue maintained in the database for further processing by the storefront-edit process through which the user identifies the sales widgets to be used to display the selected items, as indicated at block 146. Each logged-in user will have his or her own queue of items that have been selected for inclusion in that user's storefronts, but until the storefront-edit process executes and associates the selected item with a particular storefront and a specific sales widget, there is no possibility of a visiting customer purchasing the item from any storefront of that user.

Links are then established between that owner's storefront and the database at block 138, as previously described, except that if the item added is from the community bulletin board, the link also associates the added item with the actual owner of the item in the database, namely, the owner who defined the item and caused the record to be included in his or her user-profile in the first instance.

In an e-commerce transaction, a visitor to a particular storefront completes a payment transaction using the common e-commerce engine. If the item being purchased is an item defined in the database by a different user (i.e., a public item), then the proceeds from the payment transaction are divided to provide the particular storefront owner with a commission at the applicable commission rate (obtained at block 852) for the sale of the public item that was previously defined by the other user. Payment can be first received by the website and thereafter shared between the particular storefront owner at which the purchase was made and the owner of the public item. Meanwhile, the owner of the public item that was just sold ships the item to the paying customer.

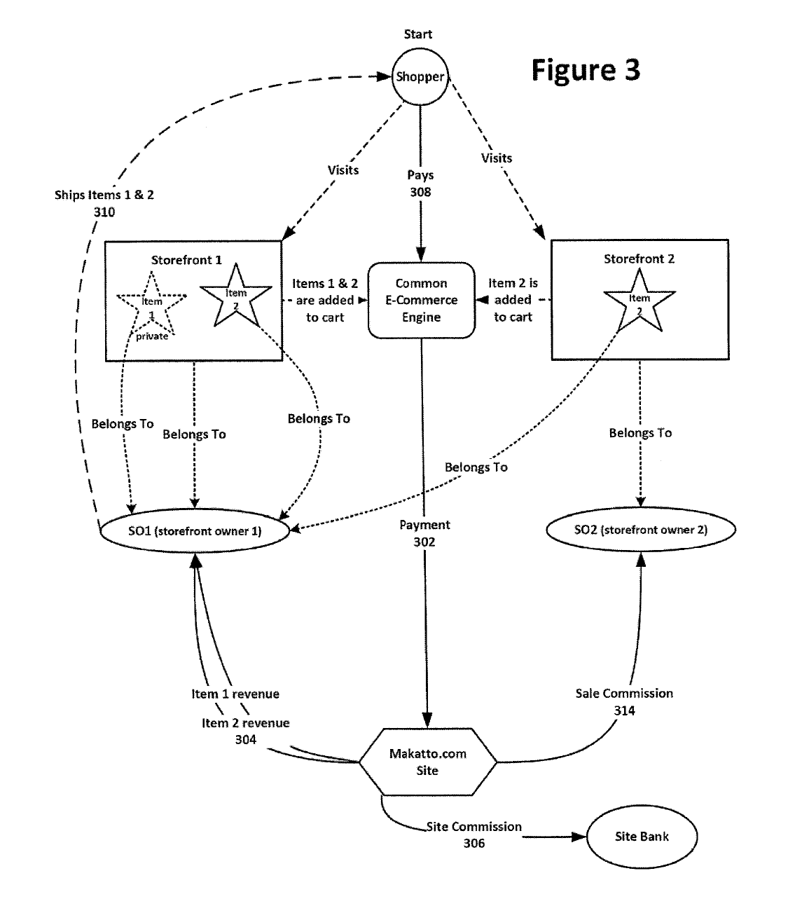

Referring now to FIG. 3, a conceptual diagram illustrates a commission-based e-commerce transaction in which proceeds are shared as described above. In FIG. 3, two storefronts are illustrated and both are hosted by a common domain, which in the illustration is “makatto.com.” These storefronts provide respective areas that visitors can navigate to within the makatto.com site, while the common domain provides a shopping cart feature which permits, among other things, a customer to purchase from multiple sellers at a single checkout point, with a unique shipping method selectable from each seller, as indicated by the common E-commerce engine. Storefront 1 includes item 1 and item 2, while storefront 2 has item 2. Storefront owner 1 (SO1) owns storefront 1 whereas storefront owner 2 (SO2) owns Storefront 2. In the example illustrated in FIG. 3, SO1 is the owner of item 1 and item 2, and has marked Item 1 private and has marked item 2 public. As a result, item 2 is published to the community bulletin board (step 134) and SO2 is able to select item 2 from the bulletin board (steps 142 and 144) so that item 2 can be included in Storefront 2. Meanwhile, item 1 is included in a private bulletin board and is only selectable by SO1 for inclusion in one or more storefronts owned by SO1.

In the example of FIG. 3, a shopper visits Storefront 2 and then selects item 2 for purchase from Storefront 2. In this case, SO1 is obligated to provide a commission to SO2 for the sale of item 2, yet a bulk of the sales revenue is provided to SO1. If the shopper were to purchase the same item from Storefront 1 by a payment 302 such as through a credit card processor or another payment service, then Storefront 2 would have no involvement in the transaction, and would not be provided any commission. Regardless of which storefront makes the sale, the common domain is provided with a commission 306 for hosting the venue. Thus, in connection with the sale of item 2 from SO2, SO2 enjoys a commission 314 and is not involved with the sales transaction other than to provide a storefront to display the goods and to receive a commission from the sale. All interchanges (disputes, shipping, etc) are handled between the shopper and SO1.

If the shopper in the example of FIG. 3 were to purchase the same item from Storefront 1, then Storefront 2 would have no involvement in the transaction, and would not be provided any commission. Regardless of which storefront makes the sale, the common domain is provided with a commission for hosting the venue in accordance with the commission rate established or otherwise applicable to that item. Thus, in connection with the sale of item 2 from SO2, SO2 enjoys a commission and is not involved with the sales transaction other than to provide a storefront to display the goods and to receive a commission from the sale. All interchanges (disputes, shipping, etc) are handled between the shopper and SO1. In the event that SO1 sells Item 1 to the shopper, SO1 is involved in all parts of the transaction (the common domain preferably still receives the proceeds in the first instance), and SO2 is not involved at all.

With further reference to FIG. 3, the shopper pays for the purchase from Storefront 2 through a payment service such as a conventional credit card. The beneficiary of the payment is the common domain (e.g., “makatto.com”). The amount charged for the item (in this example, item 2), including any fees due to SO1, is transferred by the payment service to the common domain. The common domain notifies at least SO1 of the sale, and optionally SO2. SO1 then ships the Item 2 to the shopper and marks the order line as SHIPPED. This shipment reduces the inventory of that item, which is reflected in the database (e.g., in the user profile of the owner that listed the item (SO1)) and updates are provided to the private and community bulletin boards, as may be the case, such as indicated at block 138. When the inventory drops to zero or to a predetermined number, respective storefront owners can manually or programmatically adjust their storefronts to account for this change. Of course, users can make such inventory adjustments at any time and not just when inventory drops to zero or a predetermined number. For instance, if the inventory goes to zero, a given storefront can have a program executing at the common domain or elsewhere that causes a different item to appear in place of the out-of-inventory item, or that causes a notification to appear that the item will be available at another time, or that enables visitors to register an interest in being informed when the item is available again.

Once the common domain is informed that the item has been shipped, the proceeds from the sale of the item can be released to SO1 and to SO2 (if a sales commission is owed). The common domain can retain a portion of the payment from the shopper as a house commission.

Another possibility is that revenues can be retained until the shopper or the delivery service provides a confirmation of receipt of the item at the shopper's designated delivery address. It is presently preferred that the common domain not hold any funds but rather handles only the commissions attendant with a transaction and passes those payments from buyer to seller swiftly.

If the shopper would like to return an item, the shopper can follow site instructions to report this to the seller (SO1). If the seller (SOD agrees, the seller is responsible for refunding to the shopper an amount specified in accordance with the terms of sale, including typically the cost of the item, any tax, and possibly shipping charges as well. In other words, the proceeds from the sales transaction can be reversed through conventional electronic accounting, including any tax collected from the purchasing shopper. On the other hand, commissions paid out to the common domain and SO2 may or may not be refundable to SO1. More generally, the host domain is a market facilitator and any disputes between the buyer and seller are to be resolved between the buyers and sellers. In particular, it is noteworthy that SO2 is not involved in the sales transaction other than to provide a storefront to attract the sale and to then receive a commission for the sale made by SO1 using SO2's ad or storefront. To the extent that there is an interchange with the shopper, such as a dispute or shipping issue, it is handled between the shopper and SO1.

In the event that the shopper commits fraud (e.g., SO1 ships Item 2 but the shopper claims that he/she has not received Item 2), the dispute may be reported to the common domain, but this is a matter for resolution between the shopper and SO1. In the event that SO1 commits fraud (e.g., ships an empty box to the shopper), the shopper can report the fraud to the common domain's administrator, but the dispute is to be resolved between the shopper and SO1.

Optionally, but not presently contemplated, the common domain can hold money in escrow pending the resolution of a dispute between buyers and sellers. For instance, if the buyer contends that the seller committed fraud (e.g., SO1 has shipped an empty box to the purchasing shopper), then the shopper can report this development to the common domain for administrative handling. The proceeds from the sale can be held in escrow by makatto.com until the situation is resolved. Also, it may be that the purchasing shopper is attempting to commit a fraud, such as by claiming that he/she has not received Item 2. In this event, the seller (SO1) can report this development to the common domain and the common domain may again hold the proceeds in escrow until the matter is resolved. Conflict resolution for Internet sales such as these can be resolved in the same manner that ebay.com and amazon.com resolve disputes. However, as noted above, a preferred implementation of the invention has buyers and sellers resolving disputes without intervention by the common domain, and any return of funds would have to be from the seller to the buyer as no funds are to be held by the common domain.

The foregoing discussion has described processes by which visiting customers can purchase and owner's can sell items through a virtual storefront. It should be noted, however, that logged-in users can purchase and sell items through their user-profiles or through the actual storefront. Another action available for selection through the dashboard (not shown) is a purchase-process by which a user can select items from the public bulletin board and purchase the item from the owner by virtue of the product being listed in the user-profile.

An owner can associate one or more storefronts under the owner's control with each other or with the storefront(s) of others owners to define a virtual department store. This is done by defining a group of stores. The group of stores, in one respect, comprises a collection of storefronts, but is further characterized as having an administrator, being able to be joined, being able to be messaged, and having its combined sales tracked, for example, in order for the group to achieve a higher rating within the common domain than its individual storefront members.

In one implementation, the interface module is configured to present to the user a list of item categories such as apparel, books, computer, electronics, footwear, miscellaneous, movies, office, video games, etc. The list is preferably interactive (e.g., hyperlinked HTML text) to present a selection of items in the category that the user selects. The storefront can then get categorized automatically based on the heuristics given from the categories of items added into the storefront. In another implementation, the interface module can include a selection of featured storefronts, department stores, featured department stores, or a combination of these. The interface module is preferably configured to permit the user to make selections interactively, such as by providing the selections as hyperlinked HTML text. The interface module can be further configured to permit items to be searched, selected and purchased without navigation to any particular storefront. A storefront has to be identified in order to complete a sales transaction, and the common domain can use business rules accessible to the code executing the e-commerce functionality in order to identify a storefront that is to receive the sales proceeds and provide the merchandise to the customer. The identified storefront can be a store selected because it has a featured status and has the item in stock, or can be a storefront that is manually selected by the purchaser of the item.

A virtual department store (“VDS”) can be established by a storefront owner, for example, to leverage the rank or popularity of a storefront. In establishing a VDS the management module 600 associates at least one storefront owned by the storefront owner with a set of other storefronts ranging from 1 to an arbitrary number so as to define the VDS. The association creates at least one linkage that provides revenue-sharing functionality as described next. The association also can create a visual linkage such as by presenting a plan view of the department store (i.e., a map). The plan view can illustrate an arrangement of the storefronts in the department store and permit navigation by enabling a selection of a storefront by clicking on the map. The visual linkage can be arrows that permit scrolling from one storefront to another, with the order of the storefronts being defined either by the VDS owner or using business logic to present the stores in a prescribed sequence.

The revenue-sharing functionality provides compensation to the VDS owner for having associated additional storefronts with his or her storefront, such as a commission for sales by a particular storefront in the VDS. In one implementation, a revenue-sharing module (“RSM”) couples to each storefront in the VDS except for one or more storefront(s) owned by the VDS creator. The RSM comprises computer code that executes on a machine such as the machine that is hosting the common domain. The RSM is configured to account to the VDS creator by providing a percentage of sales or other remuneration for any sales transactions completed at the storefronts included in the VDS. The code is preferably also configured to monitor transactions completed by the storefront owners in the VDS either for reporting purposes to the VDS creator or for auditing payments to the VDS creator. The RSM serves to reward the VDS creator for permitting other storefronts to be associated with the VDS creator's storefront. The other storefront owners might join the VDS and provide remuneration for this privilege if the VDS creator's storefront has a high rank or popularity, among other reasons. A consumer can navigate to the VDS, such as by selecting it through the interface module or by entering one of the stores that is in the VDS group. Any sale completed at a VDS store is tracked by the RSM in order to compensate the VDS creator.

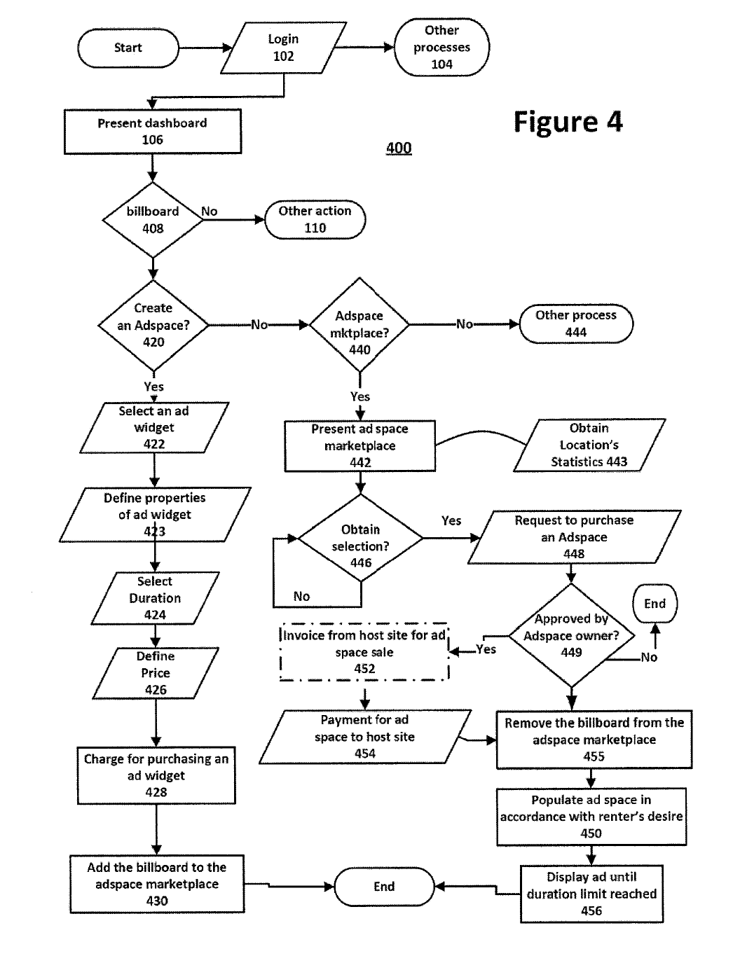

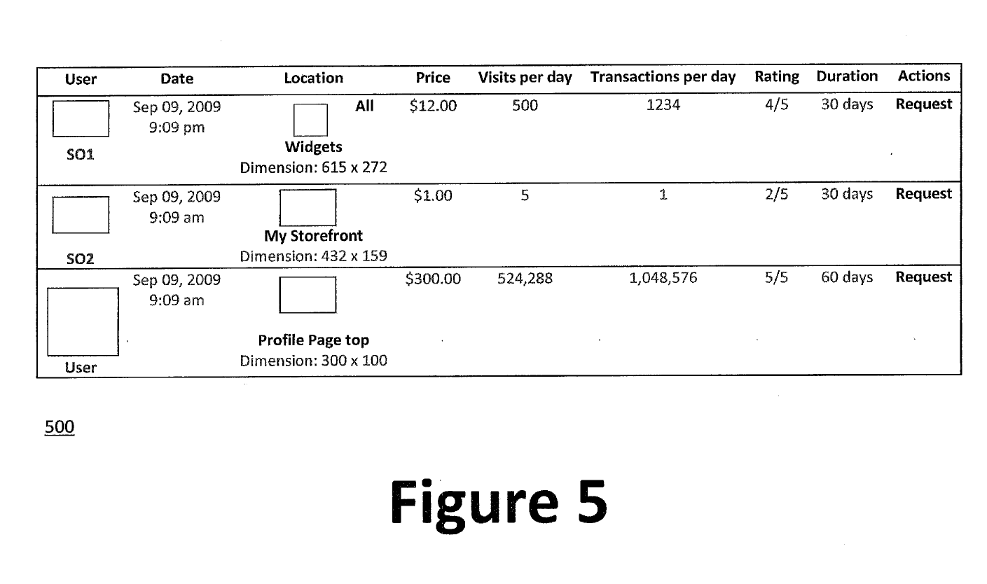

Turning next to FIGS. 4 and 5, another salient aspect of the present invention concerns managed interactions between a visitor and a given storefront to promote transactions at particular storefronts within the common domain. The interactions of FIGS. 4 and 5 concern a marketplace for establishing ad space at a given storefront and for leasing the ad space to other storefront owners. Ad space is established through the inclusion of ad widgets within storefronts, within a publicly viewable portion of a user-profile, and such.

An ad widget is a container that can display an ad that has been defined by a storeowner for inclusion in different areas, such as within a storefront, or at any other location of the common domain, including the user profile page(s), or at other hosted sites. An ad widget has properties such as the MIME type (such as an image/png or text/javascript so that the ad widget can be included on other websites, its dimensions (if storefront ad widget is selected), and so forth as will be appreciated from the discussion below. Visitors can interact with the ad widgets, as described further below in the context of a storefront. Ad widgets can be leased or sold for inclusion in any number of hosted sites that have multiple users, such as facebook.com or myspace.com, as two non-limiting examples, in which case the ad widget can comprise, in addition to the properties noted above, a browser plug-in or other active code that is available when interacting with a networking website and the marketplace can be within that hosted site or a different hosted site.

In FIG. 4, a process 400 begins as described above in connection with FIG. 1, with a user logging in and being presented with a dashboard, as indicated at blocks 102 and 106. The user has various options that can be selected through the dashboard, and at block 408 the user's actions are tested to see whether the user has indicated that he or she wishes to interact with the common domain's ad space marketplace either by establishing an ad widget or by managing or leasing an existing ad widget. In the example that follows, the user is a storefront owner that wishes to place an ad, and the storefront owner is referred to as an “ad owner,” but it should be understood that the ad owner can be an entity other than a storefront owner. In general, ad owners have selections of ads to be used in various ad spaces. These ads can contain links to storefronts as well as to other areas on the site along with other places like their own facebook.com pages or websites.

In order to have ad space in the marketplace for presentation to other ad owners, a user (“the ad space owner”) must select the ad widget from the common domain. In one variation, the ad widget is purchased from the common e-commerce engine. Referring now to blocks 420 and 422, if the user has decided to create an ad space, as tested at block 420, then an interface component is presented to the user that permits the user to select an ad widget, which is displayed in any of the locations noted above (e.g., the storefront or the user-profile), and to define the selected ad widget's properties, such as the dimension and the position, as indicated at block 423. For example, if the ad widget for the storefront is selected, the larger the ad space, the less space remains for the user's own storefront. The user may prefer to have several ads of smaller size that can be rented separately to different users than to have one large space reserved for one ad, and in a variation of the foregoing, the ad space widget can be configured to permit the same ad space to be sold to multiple users that can all advertise on the same ad widget. More typically, however, the ad widget is configured to allow a single ad at a time. At block 424, the user selects a duration that another ad owner can rent the ad space provided by the ad widget purchased at block 420. In other words, the duration parameter defines the number of days that a renter can have its ad displayed through the owner's ad widget. Optionally, only the renter (i.e., the ad owner) can terminate the ad posting at any time. If the ad space owner has decided to terminate the ad posting such that the rented duration is less than what was originally agreed upon, ad space owner may have to refund monies to the renter, for example, a prorated amount for the unused time.

At block 426, the user defines the price to rent the ad space to other users who would want to advertise on the ad space. At block 428, the user can be charged for purchasing the ad widget selected at block 422 of the properties and duration that were defined at blocks 423 and 424, respectively. Payment for the ad widget (and for the other payment transactions described herein) is conducted through the common e-commerce engine. Optionally, the size and duration parameters can be changed by the ad space owner after the ad widget has been purchased.

Once the ad widget has been paid for, assuming there is a charge, it is added in the ad space marketplace for selection by other store owners, as indicated at block 430. As illustrated in FIG. 5, the ad space marketplace comprises a page 500 maintained by the common domain that is configured through executing code to present a listing of available ad spaces at specific storefronts that can be leased by other storefront owners in order to provide a link from the ad to a URL, which can be outside of the common domain or part of the common domain such as the other storefront owner's storefront, or to display sales widgets (or items) within the ad, or otherwise present an ad to a visitor of the storefront with that ad space. As illustrated, two users presently have ad space available for renting, each of different durations and locations, such as storefront and profile, with defined properties including dimensions. An ad owner interested in renting ad space would do so in order to provide a link from the rentable ad space over to his or her URL, or to directly display sales widgets within the rentable ad space, or for other purposes, as previously noted. The ad owner that wishes to rent ad space (“Renter”) is presented with prices as well as statistical parameters such as described above and illustrated in FIG. 5 in order to select which ad space to rent. The price for renting the ad widget is determined by its owner (“Price”) at block 426, and is the fee that the renter must pay to advertise in the ad space provided by the ad widget. However, the best pricing for a given ad space will be determined in the marketplace in view of the prices set and the statistics for other ad spaces with comparable statistics.

When an ad space owner wishes to rent ad space within the common domain, he or she logs in and accesses the dashboard, as described above at blocks 102 and 106, and the user's actions are tested at block 408 to see whether the user has indicated that he or she wishes to interact with the ad space marketplace. If the store owner does wish to interact with the ad space marketplace, then a test as indicated at block 440 causes the ad space marketplace 500 to be presented, as indicated at block 442. Otherwise, some other process is invoked, as indicated by terminator 444.

At block 443, statistics concerning the location that will host the ad widget are obtained. This can be done in response to data input by the ad owner, or provided automatically using information maintained a management module 600 executing within the common domain. The statistics are useful to other ad owners in deciding whether to rent the ad space because the statistics can inform a decision by providing a gauge as to the visitor traffic, completed purchase transactions, and popularity of the site. Thus, for instance, among the parameters that can be obtained is the average number of unique visits to the host location over, say, the past seven to thirty days (“Visits per Day), and the number of daily transactions that are processed through the host location where the ad is to be displayed (“Transactions Per Day”), or the community rating for the host location (“Rating”).

It will be appreciated that the tests at blocks 408, 420 and 440 are representative of an indication being received from the user and actions taken in response. For purposes of illustration, the tests are shown as decision blocks because that permits sequential discussion of the various possible events; however, the invention is not so limited. In a given implementation, the actions of a user can be discerned by an event-driven scheme such as, by way of example and not limitation, mouse-clicks performed over appropriately-coded software objects.

The ad space marketplace 500 presented at block 442 will include any billboards added to the marketplace at block 430. The user can select from among the available ads, as indicated at block 446, and upon doing so shall be charged the amount set by the ad space owner that placed the space for rent. At block 448, the user pays the ad space owner for the ad space.

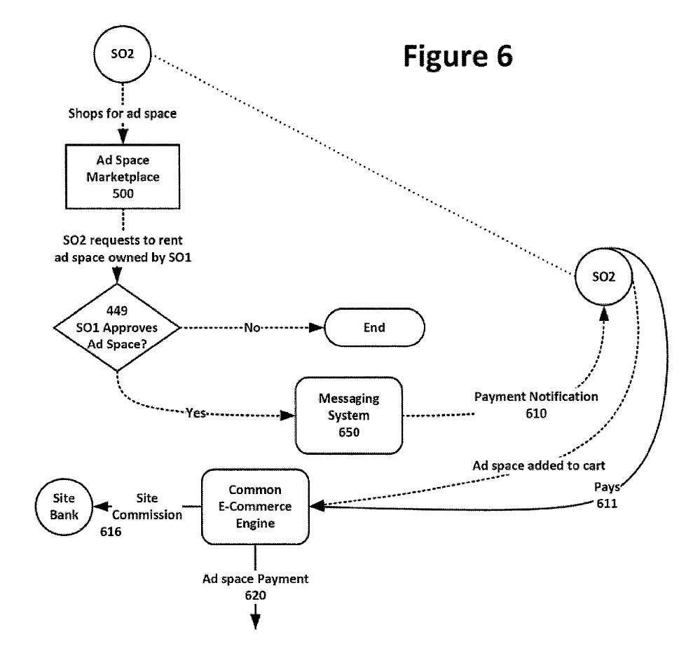

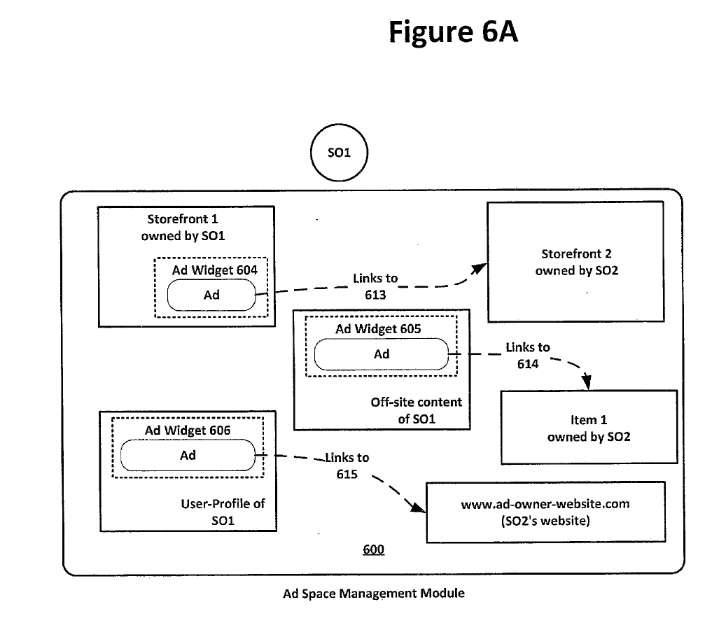

Referring briefly to FIG. 6A, preferably a management module 600 includes code executing on a server of the common domain that is operative to provide messaging and control functions to the various storefront owners. The management module 600 can be the same module that renders the each owner's storefront, or can be a different module.

When one user (SO1 or the “ad space owner”) purchases an ad widget using a process such as described previously with respect to blocks 420-428 of FIG. 4, the ad space management module causes a payment from an account of SO1 to the common domain through the common e-commerce engine. Once the ad widget has been paid for, the ad widget indicated at blocks 604, 605, and 606 is delivered to SO1 by the management module 600 and can be included in the ad space marketplace 500 for selection by other ad owners, as indicated at block 430. The ad space marketplace is where all of the ad space owners of the common domain can list their ad spaces and provide related information such as the duration of ad, its dimensions, the storefront's rating, the storefront's sales per day, the storefront's visits per day, and the like. When an ad owner (SO2) selects an ad space to rent through a process such as described previously with respect to blocks 440-446 of FIG. 4, the renting of the ad space will be pended until the ad space owner approves it. Once the ad space has been approved, a payment notification, indicated by dashed arrow 610, will be sent to SO2 using a messaging system 650 comprising code executing in a host machine. SO2 can then add approved ad spaces to the shopping cart, and the payment is made through the common e-commerce engine. In FIG. 6, the payment is indicated by a solid arrow 611. After the payment is made, the ad space 604 for that ad widget of SO1 is made available to SO2, as indicated by arrow 613. In addition, if SO2 also rents ad spaces 605 and 606, they will also be made available to SO2 as indicated by arrows 614 and 615.

Referring now to FIGS. 4 and 6, the storefront owner 2 (SO2) can now populate the ad space 604 in accordance with his desires, as indicated at block 450, and typically this will include a link from SO1 to the SO2 storefront, an ad for an item that can be purchased from SO2 (indicated by 614), or an ad to a generic URL (indicated by 615), though the ad can be filled in other ways. However, to avoid other users to purchase the same ad space before the ad space expires, the ad space must be removed from the publicly viewable marketplace at block 455. A commission paid to the common domain as indicated by arrow 616 is taken out directly from the ad space sale through the common e-commerce engine, in which SO1 only receives a portion amount of the ad space sale. This payment is handled by the common e-commerce engine. The rented ad space 604-606 can display an ad of SO2 throughout the duration specified in the ad space marketplace for any particular ad widget that has been selected (e.g., 1 month), as indicated at block 456. It is also noted that the ad space owner is not allowed to modify or delete the ad space throughout the duration specified in the marketplace without consent from the ad owner, who rents the ad space. The payment 620 is illustrated in FIG. 6 as being through the common e-commerce engine, and this can be achieved, by way of example, using Paypal, though it will be appreciated that the common site could be arranged to make payments and transact with various owners using direct deposits, checks, electronic fund transfers, credit cards, etc., and vice versa.

Among other functions, the management module 600 collects information about the success of ads in the ad space on which storefronts or profiles of the ad space owners, are visited by customers, where sales transactions are consummated, whether they were transacted in a virtual department store (VDS) and, if so, which VDS so that the creator can be remunerated, and also collects data on which ads are clicked or not. As well, the management module can include messaging other than described above to achieve further purposes such as surveys of customers to garner further information that can be used to rank, rate, or otherwise distinguish the storefronts. This information can be provided through the ad space marketplace to create an efficient market in the pricing of ad space rentals.

Any messages that are to be sent by the messaging system 650 are preferably sent under control of code executing in the hosting machine. Thus, modules described herein can cause messages to be sent under program control and without human intervention in response to events and other triggers, automatically.

The interface module, control panel module and all modules, software and code discussed herein can be constructed through program code that executes on a processor of a machine, e.g., as software in order to provide the functionality described herein.

It should be understood that the flow diagrams of FIGS. 1 and 4 are for illustration and that an implementation of the present invention needs not follow a linear flow path but instead could be event-driven. The flow diagrams, therefore, are simply an expedient for describing functional blocks in the operation of a particular embodiment of the invention and not as limiting the invention to the particular flow being illustrated.

I claim:

1. A computer-implemented method for supporting e-commerce at a website, comprising the steps of:
a. dividing the website into discrete storefronts within a database, each storefront having an owner and a respective set of items for purchase, wherein the discrete storefronts share a common e-commerce engine executing on a processor of a machine that receives and processes any payment transaction made by a visitor when purchasing an item;
b. providing a control panel module for a particular owner to add items to a particular storefront for purchase, the control panel module comprising code executing on the processor of the machine and being in communication with the database;
c. presenting to the particular owner on an output device connected to the machine any items that were previously defined by that particular owner through the control panel module, and selectively presenting to the particular owner a public subset of further items included among the sets of items of the respective storefronts of other owners;
d. adding at least one of the presented items to the particular storefront in response to a command received through the control panel, wherein the adding step comprises updating contents of the database;
e. in the event that any added item is an item for purchase from one of the other owners, associating the added item with the respective other owner in the database; and
f. completing a payment transaction by the visitor at the particular store using the common e-commerce engine, wherein any proceeds from the payment transaction are received by the website and then shared between the particular owner and the respective other owner.

2. The method of claim 1, including the additional step of defining an item to be added to the particular storefront, wherein the defining step includes marking the item in the database as a public item for inclusion in the public subset of further items.

3. The method of claim 1, including the additional step of providing tools through the control panel module for customizing each storefront so as to present a unique GUI to the visitor.

4. The method of claim 1, wherein the proceeds from the payment transaction are received by a third-party payment service prior to being received by the website.

5. The method of claim 1, wherein the common domain is provided with a commission.

6. The method of claim 1, wherein the proceeds of the payment transaction are shared with the respective other owner by transferring a commission that is calculated using a default commission rate times a price paid for the added item associated with the respective other owner.

7. The method of claim 1, wherein the proceeds of the payment transaction are shared with the respective other owner by transferring a commission that is calculated using a commission rate established by the particular owner times a price paid for the added item associated with the respective other owner.

8. A computer-implemented method for supporting e-commerce at a website, comprising the steps of:
a. dividing the website into discrete storefronts within a database, each storefront having an owner and a respective set of items for purchase by a customer, the discrete storefronts each being defined in part by a user-profile associated with the owner and being rendered through a user-interface module;
b. providing a control panel module for a particular owner to add items to the user-profile for rendering within a particular storefront and for purchase by the customer, the control panel module comprising code executing on a processor of a machine and being in communication with the database;
c. presenting to the particular owner on an output device connected to the machine any items that were previously defined by that particular owner through the control panel module, and selectively presenting to the particular owner a public subset of further items included among the sets of items of the respective storefronts of other owners;
d. adding at least one of the presented items to the user-profile of the particular owner in response to a command received through the control panel, wherein the adding step comprises updating contents of the database;
e. in the event that any added item is from the public subset of further items, associating said added item with the user-profile of the respective other owner in the database;
f. completing a payment transaction between the customer and the particular storefront to purchase said added item; and
g. automatically communicating a message under software control to the respective other owner that a commission is to be paid for the purchase of said added item from the particular storefront.

9. The method of claim 6, wherein the website operates under the influence of a management module that comprises code executing in the machine and wherein the management module accesses the user-profiles of the owners and generates the communicated message.

10. The method of claim 6, including the additional step of defining an item to be added to the particular storefront, wherein the defining step includes marking the item in the database as a public item for inclusion in the public subset of further items.

11. The method of claim 8, wherein the step of selectively presenting the public subset of further items comprises presenting only those items marked as public items.

12. The method of claim 6, wherein the adding step comprises:
including each added item in a selection queue associated with the particular owner, wherein the queue is maintained in a memory of the machine,
processing the selection queue using the processor so as to associate each added item with a particular sales widget,
rendering each added item together with the particular sales widget, and providing the rendering on the output device.

13. The method of claim 6, including the additional step of providing tools through the control panel module for customizing each storefront so as to present a unique GUI to the customer.

14. The method of claim 6, wherein the proceeds from the payment transaction are received by a third-party payment service prior to being received by the particular storefront.

15. The method of claim 6, wherein the proceeds of the payment transaction are shared with the respective other owner by transferring a commission that is calculated using a default commission rate times a price paid for the added item associated with the respective other owner.

16. The method of claim 6, wherein the proceeds of the payment transaction are shared with the respective other owner by transferring a commission that is calculated using a commission rate established by the particular owner times a price paid for the added item associated with the respective other owner.
